(19) United States
(12) Patent Application Publication
(10) Pub. No.: US 2022/0025595 A1
(43) Pub. Date: Jan. 27, 2022

(54) The Heat Wand

(71) Applicant: Gregory Kamau Jackson, Snellville, GA (US)

(72) Inventor: Gregory Kamau Jackson, Snellville, GA (US)

(21) Appl. No.: 16/947,176

(22) Filed: Jul. 21, 2020

(51) Int. Cl. E01H 5/10; H05B 3/20; E01H 5/02

(52) U.S. Cl. CPC E01H 5/108; E01H 5/02; H05B 3/20

(57) ABSTRACT

The Heat Wand is designed to speed up and ease the process and method for snow and ice removal. The Heat Wand couples a heating plate to a shaft that extends the heating plate from your hand to the ground. Powered by your household outlet through the Heat Wands' power supply cord. The innovative aspect of the Heat Wand is that the user does not have to exert any force to remove snow or ice as the Heat Wands' heating plate does all the work by melting them. The user also does not have to wait until the rock salt takes effect. This is achieved by connecting the power supply cord to the heating plates' terminals, conducting electricity through the heating plate creating heat dissipation in turn melting the snow and ice.

### BACKGROUND OF THE INVENTION

The Heat Wand attempts to solve the taxing and inconvenient method of removing snow and ice during extreme cold weather. Currently in order to remove snow and ice one has to risk life and limb shoveling or waiting for rock salt to melt ice. The Heat Wand solves all mentioned problems by generating heat by way of conducting electricity through a heating plate connected to a telescopic shaft held by the user to melt snow and ice. The Heat Wand was conceived because of the consistent seasonal injuries and deaths cause by the hazards of walking, and driving on snow and ice and from shoveling snow. The Heat Wand was also conceived out of the need to speed up the time consuming ice melting process of spreading rock salt on ice.

### BRIEF SUMMARY OF THE INVENTION

The Heat Wand is an apparatus that solves the problem of waiting for snow and ice to melt off of concrete walk ways and streets and tiresome snow shoveling. The Heat Wand achieves this by attaching an electrically powered iron heating plate to an aluminum shaft held by the user. The electricity heats up the heating plate then uses the dissipated heat to melt ice and snow.

The Heat Wand

### BRIEF DESCRIPTION OF THE SEVERAL VIEWS OF THE DRAWINGS

FIG. 1: Shows the Left Side View of The Heat Wand

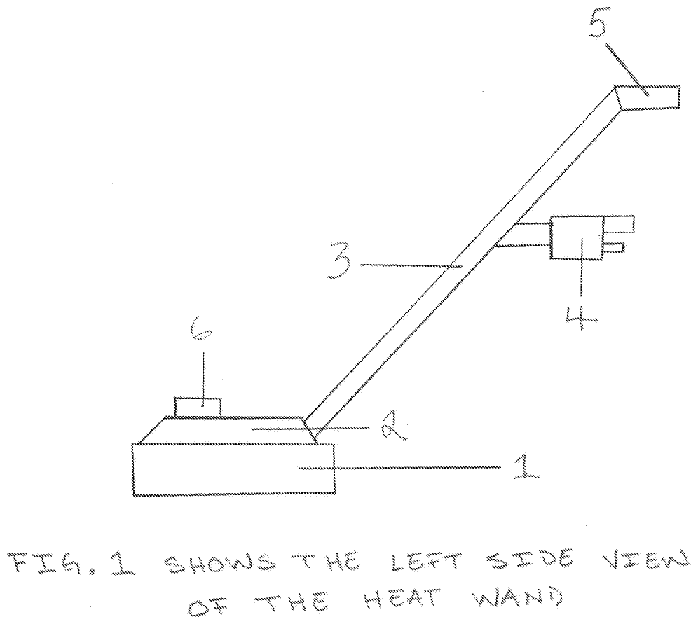

FIG. 2: Shows the Bottom View of The Heat Wand

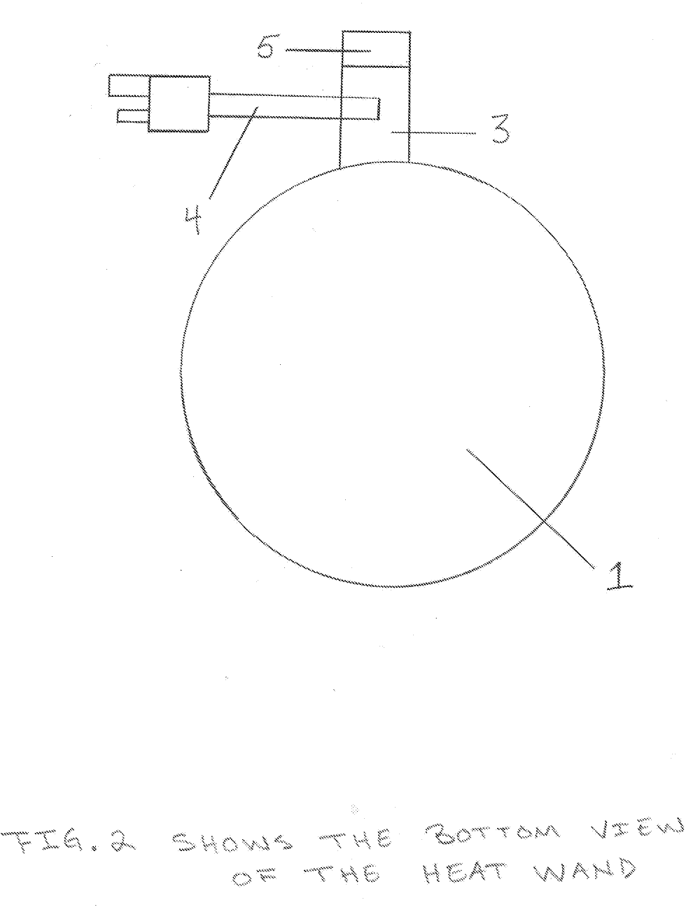

FIG. 3: Shows the Electrical Schematic of The Heat Wand

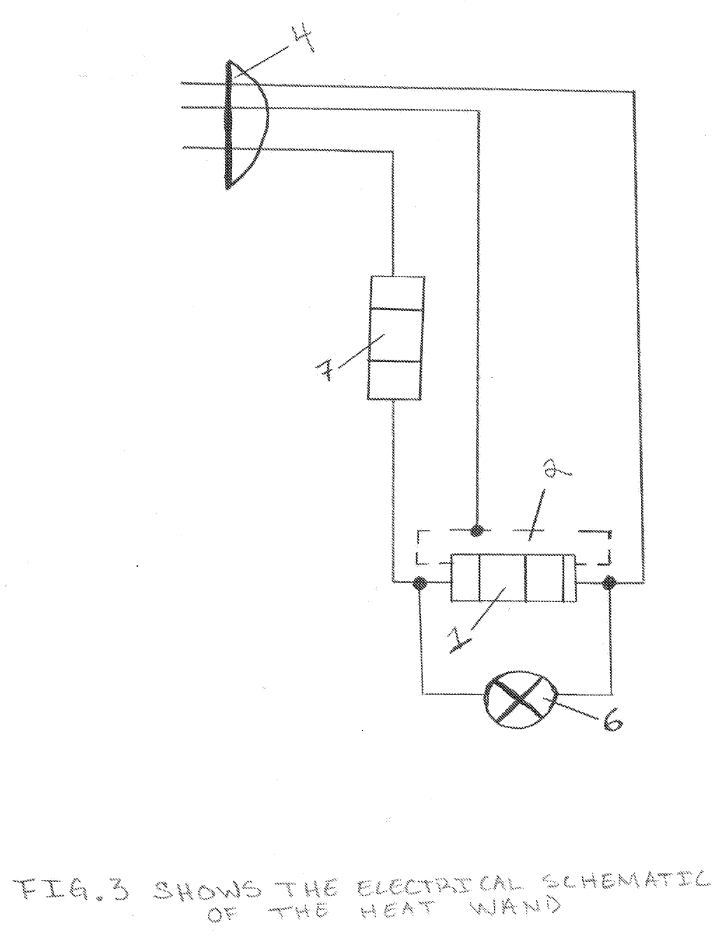

The Heat Wand is a (1) heating plate attached to a (2) shaft coupler which is attached to the (3) telescopic shaft then to the (5) handle. The heating plate is powered by a common household (4) power supply cord.

The manner and process of making the Heat Wand will be by way of plastic injection molding for the plastic parts of the invention which are the (5) handle and (2) shaft coupler. The (4) power supply cords positive and negative wires will be soldered to the positive and negative terminals of the (1) heating plate and (6) indicator lamp. The (4) power supply cords ground wire is screwed into the under surface of the (2) shaft coupler. The Heat Wand also has a (7) short circuit protection thermal fuse between the positive power supply cord wire and the positive terminal of the heating element to ensure the heating element does not short and cause a fire hazard.

The Heat Wand will be used by powering the (1) heating plate and in turn generating heat that melts snow and ice during extreme winter seasons.

The Heat Wand sets itself apart from the current alternative of shoveling and applying rock salt or de-icer by heating snow and ice to a boil then ultimately evaporated. The Heat Wand uses the (3) telescopic shaft to extend the (1) heating plate to the ground by the user allowing the (1) heating plate to melt snow and ice.

1. The Heat Wand is an apparatus that melts snow and ice during extreme weather by heating them to a boil then ultimately evaporation.
